(19) United States
(12) Patent Application Publication
(10) Pub. No.: US 2013/0160998 A1
(43) Pub. Date: Jun. 27, 2013

(54) Lost Circulation Materials and Methods of Using Same

(71) Applicants: Francois M. Auzerais, Boston, MA (US); Dzevat Omeragic, Lexington, MA (US); Slaheddine Kefi, Velizy Villacoublay (FR); Dean M. Homan, Sugar Land, TX (US); John P. Horkowitz, Sugar Land, TX (US); Benoit Vidick, Cambridge (GB); Dominique Malard, Houston, TX (US); Robert Utter, Sugar Land, TX (US); Andrew Hawthorn, Missouri City, TX (US)

(72) Inventors: Francois M. Auzerais, Boston, MA (US); Dzevat Omeragic, Lexington, MA (US); Slaheddine Kefi, Velizy Villacoublay (FR); Dean M. Homan, Sugar Land, TX (US); John P. Horkowitz, Sugar Land, TX (US); Benoit Vidick, Cambridge (GB); Dominique Malard, Houston, TX (US); Robert Utter, Sugar Land, TX (US); Andrew Hawthorn, Missouri City, TX (US)

(21) Appl. No.: 13/335,983

(22) Filed: Dec. 23, 2011

(51) Int. Cl. E21B 47/10; G06F 19/00; G01V 3/30; C09K 8/03; E21B 43/00

(52) U.S. Cl. 166/250.08; 507/100; 507/140; 507/104; 507/117; 507/118; 166/279; 702/6

(57) ABSTRACT

Compositions of lost circulation materials are provided that are useful for identifying the location of fluid loss in a wellbore. The compositions include additives which enhance a property of the composition such that they can be detected by an LWD or MWD tool capable of measuring the property when the composition is deployed in a region of loss, and can be distinguished by the LWD or MWD tool from the formation and mud fluid. Methods are also provided for using the composition to detect the location of fluid loss and for controlling the loss of fluid from the wellbore. The methods involve deploying the compositions in loss regions by adding the compositions to drilling mud, and measuring a property of the compositions using an LWD or MWD tool.

### FIELD

The present disclosure relates to drilling wellbores in subterranean formations. The present disclosure also relates to compositions of lost circulation materials and methods of using the compositions, such as for detecting the location of drilling fluid loss from a wellbore and for controlling loss of drilling fluid from a wellbore during drilling.

### BACKGROUND

Oil or gas located in a subterranean formation can be recovered by drilling a wellbore into the formation. Drilling operations can involve the use of drilling mud, which has a number of functions including lubricating the drill bit, carrying drill cuttings to the surface, and/or balancing formation pressure exerted on the wellbore. Pressure differentials between the wellbore and formation, fractures in the formation, and/or large vugs, among other causes, may result in undesirable loss of drilling mud from the wellbore (“lost circulation”). Lost circulation during drilling operations introduces hazards, costs, and potentially compromises the quality of zonal isolation. In some cases, drilling operations are stopped until the lost circulation is sealed and fluid loss to the fracture is reduced to an acceptable level. In other cases, lost circulation can result in the loss of the well altogether. It is estimated that lost circulation costs the drilling industry hundreds of millions of dollars per year.

Control of lost circulation has generally been handled according to one of two methods. A first method is avoidance, wherein geological features are mapped, and D&M and wireline measurements are used, to identify candidate wells and guide the well trajectory. A second method is reactionary, wherein when drillers experience fluid loss with no mud return to the pit, they shut off mud pumps, pick up off bottom, look in the annulus to see if it contains fluids, and if so cut back on mud weight (“MW”) and start pumping lost circulation materials (“LCM”). If the fluid column height becomes too low due to a major drop in effective MW, the driller will kick on a trip pump to fill the hole in order to prevent a blowout. If the well continues to lose mud, the driller will keep pumping LCM. There are a variety of LCMs, and the effectiveness of the particular LCM being pumped depends on where the fluid loss zone is and also where the losses are distributed along the wellbore. However, currently there is a lack of knowledge regarding accurately locating the lost zone, which is an obstacle to effectively and efficiently managing lost circulation.

### SUMMARY

The present disclosure relates to compositions comprising lost circulation materials. In some embodiments, the composition is formulated to increase the conductivity of a non-conductive drilling mud, or increase the resistivity of conductive drilling mud in order to enhance the response of an electromagnetic tool. In some embodiments, the composition is formulated to have an in situ conductivity or resistivity that distinguishes the composition from the drilling mud to which it is added when deployed in a region of loss.

In some embodiments, the compositions are formulated from known or existing lost circulation materials and have electrical properties such that when the composition is deployed in a region of loss, it can be detected by an electromagnetic tool and, in further embodiments, distinguished from the normal drilling mud (i.e. drilling mud without the added composition). In some embodiments, the compositions are formulated from known or existing lost circulation materials and a dopant which enhances the electrical properties of the composition such that when the composition is deployed in a region of loss, it can be detected by an electromagnetic tool and, in further embodiments, distinguished from the normal drilling mud. In some embodiments, the compositions include a conventional or existing LCM composition and a dopant, wherein the dopant enhances the electrical properties of the composition such that when the composition is deployed in a region of loss, the composition can be detected by an electromagnetic measurement tool. In some embodiments, when the composition is deployed in a region of loss, the composition can be distinguished from the normal drilling mud by an electromagnetic measurement tool.

In some embodiments, wherein the LCM is compatible with a non-conductive drilling fluid, the dopant enhances the electrical conductivity of the LCM. In some embodiments, wherein the LCM is compatible with a non-conductive drilling fluid, the dopant is a material having an electrical conductivity ranging from about 1 S/m to about 5×10̂7 S/m. In some embodiments, wherein the LCM is compatible with a conductive drilling fluid, the dopant enhances the electrical resistivity of the LCM. In some embodiments, wherein the LCM is compatible with conductive drilling fluid, the dopant is a material having an electrical resistivity ranging from about 100 Ohm.m to about 10̂25 Ohm.m. In some embodiments, the LCM compositions, when in use result in a mud resistivity change in a fracture from about 100 ohm.m or more corresponding to the original drilling fluid resistivity to about 1 ohm.m, or from about 2 ohm.m or more corresponding to the original drilling fluid resistivity to about 1 ohm. m. In some embodiments, the LCM compositions, when in use, result in a resistivity increase in a fracture from about 1 ohm.m or less corresponding to the original drilling fluid resistivity to about 100 ohm.m or higher.

In some embodiments, the dopant can be rubber, glass, wood, insulating polymers, conductive fibers, metallic particles, and mixtures thereof. In some embodiments, the dopant is present in the composition in an amount sufficient to enhance the response of an electromagnetic tool used in wellbore drilling operations such that it can detect the compositions when deployed in a region of loss. In some embodiments, the dopant is present in the composition in an amount sufficient to electrically enhance the response of an electromagnetic tool used in wellbore drilling operations relative to the tool's response when only the lost circulation material is used. In some embodiments, dopant is present in the composition in an amount ranging from about 0.1 lbm/bbl to about 400 lbm/bbl, or from about 0.5 lbm/bbl to about 100 lbm/bbl, or from about 2 lbm/bbl lto about 10 lbm/bbl, or from about 1.5 kg/m3 to about 30 kg/m3. In some embodiments, the dopant is present in the composition in an amount ranging from about 0.01% to about 40% volumic fraction of the total fluid pumped, or from about 0.05% to about 10% volumic fraction of the total fluid pumped, or from about 0.2% to about 1% volumic fraction of the total fluid pumped.

The present disclosure also relates to methods of using the compositions, for example to detecting the location of fluid losses. In some embodiments, the method includes adding any one of the above-described LCM compositions to the drilling mud, and thereafter using a resistivity tool to take one or more measurements in a wellbore to which the LCM composition was added. In some embodiments, the LCM composition is added to the drilling fluid in an amount ranging from about 5 lbm/bbl to about 400 lbm/bbl, or from about 15 kg/m3 to about 1200 kg/m3. In some embodiments, one-hole volume of doped, LCM-containing drilling fluid is circulated through the wellbore; thereafter a bottom hole assembly (“BHA”) including an electromagnetic resistivity measuring tool is moved through the borehole, while simultaneously acquiring resistivity measurements; and, a fluid loss region is detected by identifying a region of higher resistivity contrast as compared to other regions. In some embodiments, the resistivity tool is a PERISCOPE™, a deep directional resistivity (“DDR™”) tool, or a Logging While Drilling (“LWD”) triaxial resistivity tool, equivalent to an Rt Scanner™ wireline induction tool.

The present disclosure also relates to methods of using the compositions, for example to control the rate of fluid loss from the wellbore. In some embodiments, the method involves generating electrical conductivity data using a resistivity measurement tool to monitor the deployment of an LCM composition according to this disclosure, for example a dielectrically-doped LCM in a region of loss, and using the data to tune the LCM composition and/or the LCM particle concentration in the drilling fluid. In some embodiments, if the wellbore continues to experience loss after deploying an initial LCM and iteratively tuning the LCM and deploying the tuned LCM, the method further comprises again adding one-hole volume of drilling mud containing an LCM composition according to this disclosure, such as a dielectrically-doped LCM, to the wellbore, again obtaining resistivity measurements by moving a bottom hole assembly containing a resistivity measuring tool through the wellbore, again identifying regions of loss based on the resistivity measurements, again deploying an LCM such as an electrically-doped LCM to any identified region of loss, and again generating electrical conductivity data for tuning the LCM composition if needed.

The identified embodiments are exemplary only and are therefore non-limiting. The details of one or more non-limiting embodiments of the invention are set forth in the accompanying drawings and the descriptions below. Other embodiments of the invention should be apparent to those of ordinary skill in the art after consideration of the present disclosure.

### BRIEF DESCRIPTION OF DRAWINGS

FIG. 1 is a partial schematic representation of a drilling system including a drilling tool and downhole assembly of a type that can be used with the compositions, and to practice the methods and systems, described herein.

FIG. 2 is a graph of numerical simulations of anisotropy phase shift measurements (59 in 100 kHz) of oil-based resistive mud and water-based conductive mud for formations having fractures of varying density and shape.

FIG. 3 is a graph of numerical simulations of first harmonic anisotropy phase shift measurements (44 in 400 kHz) of very resistive (typical oil-based) mud and very conductive (typical water-based) mud for formations having fractures of varying density and shape.

FIG. 4 is a graph of numerical simulations of second harmonic anisotropy attenuation measurements (44 in 400 kHz) of very resistive (typical oil-based) mud and very conductive (typical water-based) mud for formations having fractures of varying density and shape.

FIG. 5 is a process flow diagram for an embodiment of a method of using compositions described herein.

### DETAILED DESCRIPTION

### I. Definitions

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrase “for example,” “such as,” “including” and the like are used herein, the phrase “and without limitation” is understood to follow unless explicitly stated otherwise.

The term “about” is meant to account for variations due to experimental error and/or measurement error or limitations.

The terms “comprising” and “including” (and similarly “comprises” and “includes”) are used interchangeably and mean the same thing. Specifically, each of the terms is defined consistent with the common United States patent law definition of “comprising” and is therefore interpreted to be an open term meaning “at least the following” and also interpreted not to exclude additional features, limitations, aspects, etc.

The terms “wellbore” and “borehole” are used interchangeably.

The terms “bottom hole assembly” and “downhole assembly” are used interchangeably.

The phrases “drilling fluid” and “drilling mud” and “mud fluid” are used interchangeably.

The term “fracture” and the phrase “region of fluid loss” are used interchangeably.

“Measurement While Drilling” (“MWD”) can refer to devices for measuring downhole conditions including the movement and location of the drilling assembly contemporaneously with the drilling of the well. “Logging While Drilling” (“LWD”) can refer to devices concentrating more on the measurement of formation parameters. While distinctions may exist between these terms, they are also often used interchangeably. For purposes of this disclosure MWD and LWD are used interchangeably and have the same meaning. That is, both terms are understood as related to the collection of downhole information generally, to include, for example, both the collection of information relating to the movement and position of the drilling assembly and the collection of formation parameters.

When the term “enhance,” “enhanced” or the like is used to indicate that a composition according to the invention has an enhanced property, the term means that the response of a tool to the composition (at least when deployed in the fracture) is improved compared to the base drilling fluid. For example “enhanced conductivity” or “electrically-enhanced” means that a resistivity tool is more sensitive to the composition (at least when deployed in the fracture) as compared to the base drilling fluid, i.e. the composition provides higher resistivity contrast than the normal drilling fluid. The improvement may be in one or more aspects of the measurement characteristics. For example, with reference to resistivity characteristics, the improvement may be with respect to sensitivity to one or more of fracture aperture, fracture density, shape of the invasion or mud resistivity, or the improvement may be with respect to the anisotropy measurement, the first harmonic measurement, and/or the second harmonic measurement.

The term “dopant” means any material which is capable of modifying the properties of an LCM composition to render it detectable by a logging while drilling tool or a measurement while drilling tool, or any material that enhances the contrast (relative to a property being measured) between a composition comprising an LCM and dopant and the formation as compared to the contrast between the un-doped LCM and the formation, with the understanding that the property or enhanced property may not be observable when the composition is added to the drilling mud but should be observed when the composition builds up in a region of loss/fracture. For example, a dielectric material can be a dopant if it modifies the electrical properties of the composition to which it is added, for example by enhancing the composition's conductivity or resistivity, with the understanding that the enhanced electrical property may not be observable when the composition is added to the drilling mud but should be observed when the composition builds up in a fracture.

Whenever the word “dopant” or “dielectric additive” or any other additive or any other component is mentioned in connection with describing the composition of products according to the disclosure, it is understood that one or more dopants, or one or more dielectric additives, or one or more of any other additive, or one or more of any other component, may be present in the composition. In other words, for example, the phrase “compositions comprising an LCM and a dopant” means “compositions comprising one or more LCMs and one or more dopants.”

The inventive compositions are alternatively referred to as LCM products (or LCM compositions) according to the disclosure, doped LCM product, doped LCM compositions, new LCM additives, LCM compositions comprising an additive, compositions comprising an LCM and an additive, and the like.

For purposes of this disclosure, “in situ” means in the fracture. Thus, the “in situ” resistivity or conductivity of an LCM composition means the resistivity or conductivity as measured when the LCM is deposited in and plugs a fracture. Similarly, the statement “when the LCM composition is in situ” means when the LCM composition is deposited in and plugs the fracture. Typically, an initial starting pill ranges from about 2 to about 40 percent solid volume fraction of LCM. When it is pumped downhole, it may start to bridge and plug at the loss zone location. Ultimately, the plug that is typically obtained is a concentrate of particles with a solid volume fraction ranging from about 50 to about 98% (for example from about 60 to about 80 percent) solid volume fraction of LCM. Thus the in situ resistivity or conductivity can be modeled by preparing a pill with an appropriate solid volume fraction of particles.

### II. General

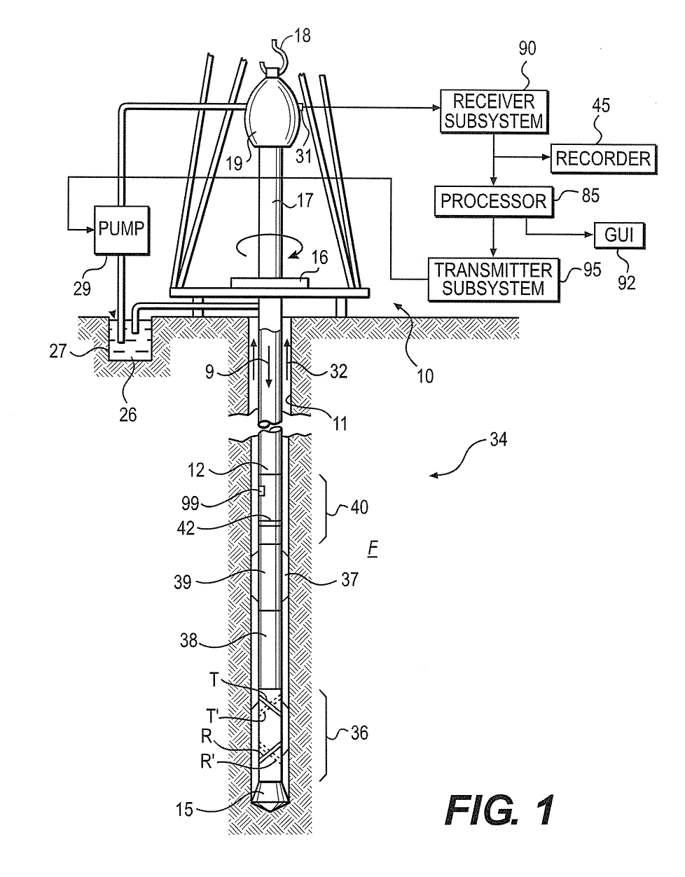

FIG. 1 illustrates a wellsite system in which the disclosed compositions, systems and methods can be employed. A land-based platform and derrick assembly 10 are positioned over a wellbore 11 penetrating a subsurface formation F. In the illustrated embodiment, the wellbore 11 is formed by rotary drilling in a manner that is known in the art. Those of ordinary skill in the art given the benefit of this disclosure will appreciate, however, that the present invention also finds application in directional drilling applications as well as rotary drilling, and is not limited to land-based rigs.

A drill string 12 is suspended within the wellbore 11 and includes a drill bit 15 at its lower end. The drill string 12 is rotated by a rotary table 16, energized by means not shown, which engages a kelly 17 at the upper end of the drill string. The drill string 12 is suspended from a hook 18, attached to a travelling block (also not shown), through the kelly 17 and a rotary swivel 19 which permits rotation of the drill string 12 relative to the hook 18.

Drilling fluid or mud 26 is stored in a pit 27 formed at the well site. A pump 29 delivers the drilling fluid 26 to the interior of the drill string 12 via a port in the swivel 19, inducing the drilling fluid to flow downwardly through the drill string 12 as indicated by the directional arrow 9. The drilling fluid 26 exits the drill string 12 via ports in the drill bit 15, and then circulates upwardly through the region between the outside of the drill string 12 and the wall of the wellbore, called the annulus, as indicated by the direction arrows 32. In this manner, the drilling fluid 26 lubricates the drill bit 15 and carries formation cuttings up to the surface as it is returned to the pit 27 for recirculation. If there are fractures in the formation, seepage of drilling fluid into the formation may occur after the drilling fluid 26 exits the drill string 12, resulting in loss of drilling fluid 26.

The drill string 12 further includes a bottomhole assembly (“BHA”), generally referred to as 34, near the drill bit 15 (in other words, within several drill collar lengths from the drill bit). The BHA includes capabilities for measuring, processing, and storing information, as well as communicating with the surface. The BHA 34 thus includes, among other things, a measuring and local communications apparatus 36 for determining and communicating the resistivity of the formation F surrounding the wellbore 11, including for determining and communicating the resistivity of compositions deployed in regions of loss in the formation. In some embodiments one or more resistivity measuring tools are used, such as for example an axial magnetic moment resistivity tool for detecting axial fractures and a tensor resistivity tool for detecting horizontal fractures. In the embodiment shown, the measuring apparatus 36 includes an azimuthally sensitive resistivity measuring instrument comprising a first pair of transmitting/receiving antennas T, R, as well as a second pair of transmitting/receiving antennas T″, R″. The second pair of antennas T″, R″ is symmetric with respect to the first pair of antennas T, R. The measuring apparatus 36 further includes a controller to control the acquisition of data, as is known in the art. The measuring apparatus 36 may be one described more fully in U.S. Pat. No. 7,382,135 (which is incorporated herein by reference) issued to Li et al. and assigned to the assignee of the present invention. The foregoing instrument is used under the trademark PERISCOPE, which is a trademark of the assignee of the present invention.

The BHA 34 further includes instruments housed within drill collars 38, 39 for performing various other measurement functions, such as measurement of the natural radiation, density (gamma ray or neutron), and pore pressure of the formation F. At least some of the drill collars are equipped with stabilizers 37, as are well known in the art.

A surface/local communications subassembly 40 is also included in the BHA 34, just above the drill collar 39. The subassembly 40 includes a toroidal antenna 42 used for local communication with the resistivity tool 36 (although other known local-communication means may be employed), and a known type of acoustic telemetry system that communications with a similar system (not shown) at the earth's surface via signals carried in the drilling fluid or mud. Thus, the telemetry system in the subsassembly 40 includes an acoustic transmitter that generates an acoustic signal in the drilling fluid (a.k.a. “mud-pulse”) that is representative of measured downhole parameters.

The generated acoustic signal is received at the surface by transducers represented by reference numeral 31. The transducers, for example, piezoelectric transducers, convert the received acoustic signals to electronic signals. The output of the transducers 31 is coupled to an uphole receiving subsystem 90, which demodulates the transmitted signals. The output of the receiving subsystem 90 is then coupled to a computer processor 85 and a recorder 45. The processor 85 may be used to determine the formation resistivity profile (or make other determinations as disclosed herein among other things) on a “real time” basis while logging or subsequently by accessing the recorded data from the recorder 45. The computer processor is coupled to a monitor 92, which employs a graphical user interface (“GUI”) through which the measured downhole parameters and particular results derived therefrom (e.g. resistivity profiles) are graphically presented to the user.

An uphole transmitting system 95 is also provided for receiving input commands from the user (e.g. via the GUI monitor 92), and is operative to selectively interrupt the operation of the pump 29 in a manner that is detectable by transducers 99 in the subassembly 40. In this manner, there is two-way communication between the subassembly 40 and the uphole equipment. A suitable subassembly 40 is described in greater detail in U.S. Pat. Nos. 5,235,285 and 5,517,464 (both of which are incorporated herein by reference), both of which are assigned to the assignee of the present invention. Those skilled in the art will appreciate that alternative acoustic techniques, as well as other telemetry means (e.g. electromechanical, electromagnetic), can be employed for communication with the surface.

### III. Compositions

The present disclosure provides compositions useful for detecting regions of fluid loss while drilling. As is known in the art, LCMs are used to block or alleviate fluid flow related to regions of loss. In some exemplary embodiments, LCMs can build up in pores or in fractures thereby blocking or alleviating seepage. In other exemplary embodiments, LCMs can bridge and cross-link across pores or fractures thereby blocking or alleviating seepage. In some exemplary embodiments, LCMs are deployed in regions of loss by circulating the LCMs with the drilling mud. The compositions according to the present disclosure are compatible with the variety of forms of LCMs and the variety of methods of deploying LCMs.

In general, the compositions according to the invention are LCM compositions formulated to have a desired property at a level that is detectable by a logging while drilling (“LWD”) or measurement while drilling (“MWD”) tool (such as for example the measurement tool 36 in FIG. 1). In some embodiments, the desired level is a level at which a downhole measurement tool can distinguish the LCM composition from the formation and the normal drilling fluid to which it is added or which is being used in the drilling operation. In some embodiments, the desired level is a level that enhances a property of the drilling fluid, wherein enhances is understood to mean that the downhole measurement tool is more sensitive to the drilling fluid with the LCM composition added than without the LCM composition added. In some embodiments, the composition is distinguishable from the normal drilling fluid, and/or enhances a property of the drilling mud only when the LCM composition collects in the fracture or region of loss. For example, the compositions can be formulated to have a desired level of a property when deployed in a region of loss. In some embodiments, the compositions are existing and/or conventional LCM products that are modified by additives which enhance the contrast, with respect to a measured property, between the composition and formation and/or the composition and the drilling fluid as compared to the unmodified LCM product and the formation or the unmodified LCM product and the drilling fluid.

In some embodiments, the desired property is the conductivity or resistivity of the composition. In some embodiments, the desired level is a level at which an electromagnetic tool can distinguish the LCM composition from normal drilling fluid to which it is added or which is being used in the drilling operation. In some embodiments, the desired level is a level that enhances the electrical properties of the drilling fluid, wherein enhance is understood to mean that an electromagnetic tool is more sensitive to the drilling fluid with the LCM composition than without the LCM composition. In some embodiments, the composition is distinguishable from the normal drilling fluid, and/or enhances the electric properties of the drilling mud only when the LCM composition collects in the fracture or region of loss. For example, the compositions can be formulated to have a desired level of resistivity or conductivity when deployed in a region of loss. For example, in some embodiments, the LCM compositions, when in use result in a mud resistivity change in a fracture from about 100 ohm.m or more corresponding to the original drilling fluid resistivity to about 1 ohm.m, or from about 2 ohm.m or more corresponding to the original drilling fluid resistivity to about 1 ohm. m. As another example, in some embodiments, the LCM compositions, when in use, result in a resistivity increase in a fracture from about 1 ohm.m or less corresponding to the original drilling fluid resistivity to about 100 ohm.m or higher. In some embodiments, the compositions are existing LCM products that are modified by additives which enhance the contrast, with respect to conductivity or resistivity, between the composition and formation (and between the composition and normal drilling fluid) as compared to the unmodified LCM product and the formation (and as compared to the unmodified LCM product and the normal drilling fluid.

In some embodiments, the composition is formulated to render the composition detectable by a resistivity tool, for example when it is deployed in a region of loss. In some embodiments, the composition is formulated to render the LCM detectable by a deep reading resistivity tool, for example when it is deployed in a region of loss. In some embodiments, the composition is formulated to render the LCM detectable by a multi-component and/or a tensor-resistivity tool, for example when it is deployed in a region of loss. In some embodiments, the composition is formulated to render the LCM product detectable by a directional resistivity tool (such as a PERISCOPE™) and/or tensor resistivity tool, for example when it is deployed in a region of loss. In any of the above embodiments the composition can be formulated from LCMs alone, or can be formulated with LCMs and an additive for enhancing the dielectric property of the composition. In some embodiments, the composition is a conventional or known LCM product to which a dopant has been added to enhance or alter the dielectric properties of the LCM product to improve the sensitivity of the electromagnetic tool to the composition or the drilling mud to which it has been added (as compared to the LCM without the additive or the drilling mud without the LCM composition).

In some embodiments, the composition comprises an LCM doped with an electrically-conductive or electrically-resistive additive such that when the doped LCM composition is deployed in a fracture, the electrically-conductive or electrically-resistive material becomes sufficiently concentrated (for example as the bridging effect takes place into the region of the wellbore taking fluids) that the fracture builds up enough contrast to be detected by an electromagnetic tool, or enhances the sensitivity of the tool to the composition. In some embodiments, the composition comprises an existing (e.g. a conventional) LCM product that has been modified to enable electromagnetic tools to identify the presence of the LCM product in a loss region, for example when losses occur in fractures located along a wellbore. In some embodiments, the existing LCM products are modified by adding one or more dopants (or one or more dielectric materials) such as one or more particulates and/or fibers with adjustable electrical conductive properties suitable for electrically enhancing the resistivity contrast between the reservoir rocks and regions of the wellbore taking fluid losses when such fiber or particulate bridge such region of the reservoir.

Exemplary existing LCM products useful in compositions according to the present disclosure include carbonate minerals, mica, rubber, polyethylene, polypropylene, polystyrene, poly(styrene-butadiene), fly ash, silica, alumina, glass, barite, ceramic, metals and metal oxides, starch and modified starch, hematite, ilmenite, ceramic microspheres, glass microspheres, magnesium oxide, graphite, gilsonite, cement, microcement, nut shells and sand.

Exemplary dopants, which may be added to the LCM products, include fibers or particles with dielectric properties, such as metallic fibers, carbon nanotube-loaded fibers, and other metallic fibers, rubber, glass, and wood. Conductive fibers are available from companies such as Hexcel Schwebel, which provides high performance fibers that are part of a family of advanced composite materials produced as reinforcement fibers. These fibers include several types of fiberglass, carbon, aramids, and specialty reinforcements. Other vendors are available that provide fibers doped with conductive material. Other exemplary dopants include electrically conductive/resistive chemicals such as electrically conductive/resistive polymers, surfactants, and nanoparticles such as carbon nanotubes.

In some embodiments, wherein the drilling fluid is non-conductive, for examples an oil-based mud, the dopant is electrically-conductive. In further embodiments, the dopant has an electrical conductivity ranging from about 1 S/m to about 5×10̂7 S/m. In some embodiments, the electrical conductivity of the dopant, and the amount of the dopant, is chosen to result in an LCM composition that is detectable by an electromagnetic tool, at least when it is deployed in a region of loss, or increases the sensitivity of an electromagnetic tool to the LCM composition itself or the drilling fluid to which it is added, at least when the LCM composition is deployed in a region of loss. In some embodiments, more than one dopant is used, each having the same electrical conductivity or together having an average conductivity ranging from 1 S/m to about 5×10̂7 S/m.

In some embodiments, wherein the drilling fluid is conductive, for example a water-based mud, the dopant is electrically resistive. In further embodiments, the dopant has an electrical resistivity ranging from about 100 Ohm.m to about 10̂25 Ohm. m. In some embodiments, the electrical resistivity of the dopant, and the amount of the dopant, is chosen to result in an LCM composition that is detectable by an electromagnetic tool, at least when it is deployed in a region of loss, or increases the sensitivity of an electromagnetic tool to the LCM composition itself or the drilling fluid to which it is added, at least when the LCM composition is deployed in a region of loss. In some embodiments, more than one dopant is used, each having the same electrical resistivity or together having an average resistivity ranging from 100 Ohm.m to about 10̂25 Ohm. m.

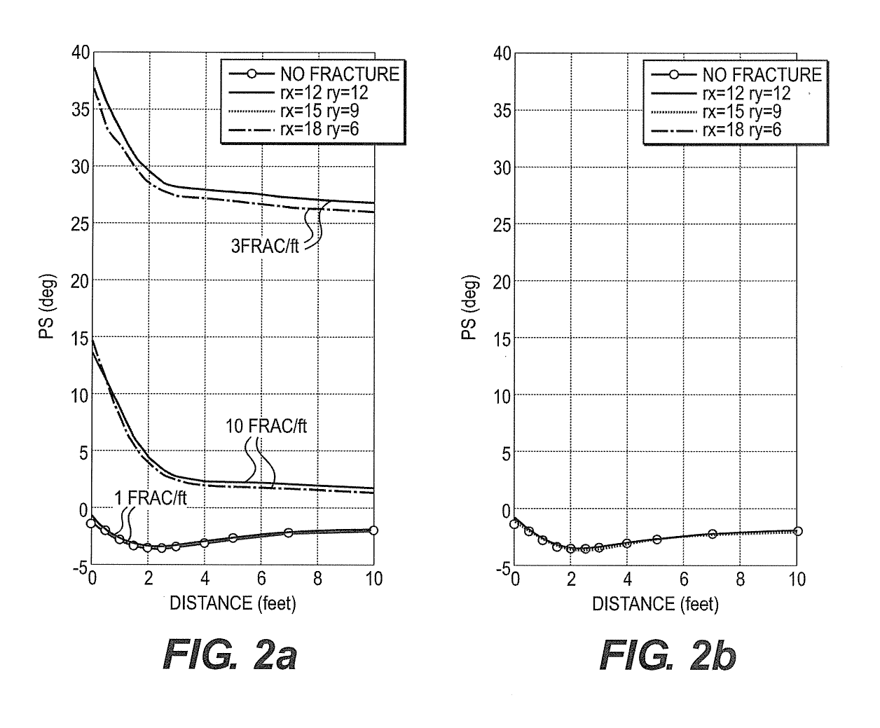

In some embodiments, the dopant is present in the composition in an amount sufficient to electrically-enhance the response of an electromagnetic tool used in wellbore drilling operations. “Electrically-enhance the response” means that the response of the electromagnetic tool to the composition (when deployed in the fracture) is improved compared to the base LCM product without the dielectric additive (or the drilling fluid without the doped LCM composition), for example the doped LCM composition provides higher resistivity contrast than the LCM product alone. The improvement may be in one or more aspects of resistivity characteristics. For example, the improvement may be with respect to sensitivity to one or more of fracture aperture, fracture density, shape of the invasion or mud resistivity. The Examples sections and FIGS. 2-4, described therein, provide further illustration of “electrically-enhance the response.” In some embodiments, the dopant is present in the composition in an amount ranging from about 0.1 to about 400 lbm/bbl, for example from about 0.5 to about 100 lbm/bbl, or for example from about 2 to about 10 lbm/bbl. In some embodiments, the dopant is present in the composition in an amount ranging from about 0.01% to about 40% volumic fraction of total fluid pumped, or from about 0.05% to about 10% volumic fraction of total fluid pumped, or from about 0.2% to about 1% volumic fraction of total fluid pumped.

In some embodiments, the compositions are prepared by mixing an LCM product with a dopant. In some embodiments, the compositions are prepared by mixing LCMs with an aqueous or non-aqueous fluid. In some embodiments, the compositions are prepared by mixing LCMs and a dopant with an aqueous or non-aqueous fluid. In some embodiments, the dopant is present in the aqueous or non-aqueous fluid, or the dopant is mixed together with the LCM product, or both. In some embodiments, the nature of the base fluid (whether aqueous or non-aqueous) is chosen to be compatible with the drilling or completion fluid. In some embodiments, preparation of the LCM composition is according to methods known in the art for preparing an LCM pill, i.e. including a base fluid, a gelling agent to suspend the LCM particles, the LCM particles, the dopant (if present) and other classical additives(if present) such as antifoam additives or biocides.

### IV. Methods

The present disclosure provides methods applicable to oil and gas production, particularly to drilling subterranean formations, and more particularly to detecting fractures in formations and controlling loss of drilling fluid from wellbores. In general, the methods involve using a logging while drilling or measurement while drilling tool (such as measurement apparatus 36 in FIG. 1) to detect the buildup of compositions (as described above) in a region of loss. In some embodiments, the LWD or MWD tool is an electromagnetic tool. In some embodiments, the LWD or MWD tool is a resistivity tool. In some embodiments, the LWD or MWD tool is a deep reading resistivity tool. In some embodiments, the LWD or MWD tool is a multi-component and/or tensor resistivity tool. In some embodiments, the LWD or MWD tool is a PERISCOPE™, a DDR™, and/or a tensor resistivity tool.

In most prior fluid lost scenarios, LCMs are chosen based on availability and/or to best fit loss zone geometry to bridge and plug a zone. Usually, the selection is only performed depending on the range of loss volume as estimated by the level of fluid tanks at the surface. To be fully effective, this selection requires a good knowledge of lost circulation zone type, the location, dimensions, and permeability of the zone as well as knowledge of the size of their smallest restrictions are and the differential pressure across the zones. In some embodiments according to the present disclosure, the use of LCM compositions in accordance with this disclosure, including doped LCM compositions (also referred to as “new LCM additive”), enables drillers to capture such information thereby also enabling drillers to optimize the concentration of the LCM composition, such as the doped LCM compositions, in the drilling mud to achieve a desired function. For example, resistivity measurements can provide geometric information to compute the maximum packing volume fraction of the fiber needed. Alternatively, or in addition, drillers could also determine the optimum size of a spherical particle so that it would be caged by the fiber network in general, and particularly by the fiber network when this network corresponds to the maximum calculated achievable packing. The correlation/analysis of data suggested herein is within the skill of the art.

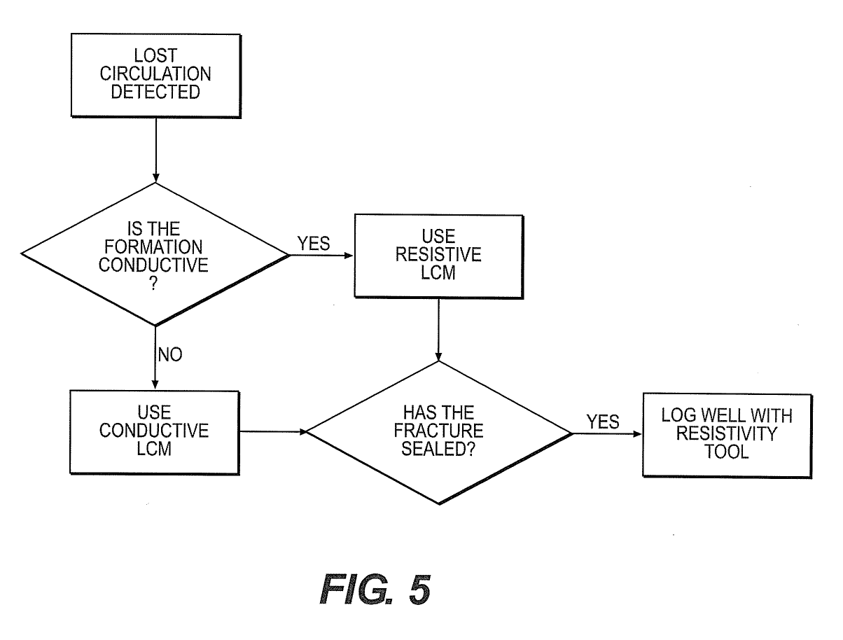

Thus, in some embodiments, once a leaky region of a wellbore is located, the methods further include optimizing or tuning the composition of the new LCM additive, for example by using data generated by downhole electromagnetic measurements and surface pressure readings. For example, the LCM particle concentration may be increased based on the generated data and surface pressure readings until the fracture is successfully plugged (i.e. fluid loss is no longer observed). In some embodiments, where fluid loss continues despite optimization or tuning of the LCM composition, including the doped LCM composition, the entire method may be repeated to determine whether there are new or additional fractures that need to be addressed. This process is generally depicted in FIG. 5, which indicates that once lost circulation is detected, a resistive LCM is added to the drilling mud if the formation is conductive whereas a conductive LCM is added if the formation is not conductive. If the fracture fails to seal, an LWD resistivity tool can be used in connection with the conductive or resistive (as appropriate) LCM for example to determine the location of the region of loss or to tune the LCM composition in an attempt to seal the identified (or previously identified) fracture. In some embodiments, one or more resistivity tools may be used. For example, an axial magnetic moment resistivity tool may be used, for example to detect axial fractures, and/or a tensor resistivity tool may be used, for example to detect horizontal fractures.

In some embodiments, the methods are applied in fractured carbonates and for losses that occur at the bit. In further embodiments, a D & M tool such as a PERISCOPE™ may be used to track the location of fluid losses (provided there is enough contrast in electrical conductivity between the fluid being pumped and the formation fluid resistivity). In some embodiments, the methods enable real time capabilities of identifying and/or controlling mud losses while drilling.

For example, in some embodiments, the method involves:

1) In a first step, if losses start while drilling, a “new LCM” (i.e. compositions according to the present disclosure) which promotes high contrast in electrical resistivity measurements is added to the mud while the bottom hole assembly (“BHA”) is at the bottom of the bore hole.

2) In a second step, after having circulated one-hole volume, the BHA is pulled out of the hole slowly and resistivity measurements can be acquired along the wellbore until the previous casing shoe is reached. Zones invaded by the new LCM can be detected in the invaded fracture as they would promote a higher resistivity contrast between the formation resistivity and the normal drilling fluids (i.e. drilling fluids that do not have new LCM added to them).

3) Once localized, the BHA would then be placed at the top of the fracture and a conventional lost circulation pill (with or without the electrically-conductive agent) could be placed accurately as a third step. In some embodiments, the resistivity/conductivity sensor would be located as close as possible to the drilling bit (e.g. no more than about 20 feet to about 30 feet) to minimize the section to be drilled with total losses before localizing the fractures.

4) While measuring, if lost control is not achieved with conventional LCM products, then new LCM is added to tune the concentration particulate in the LCM pill and increase the percentage of solid bridging agent until the desired effect of stopping the losses is achieved.

5) If it appears the LCM is not plugging the identified region of loss of the wellbore, it should be assumed that a new region of the wellbore is developing lost fluid and the process should be repeated.

The methods are applicable to both conductive fluid (e.g. water-based fluid) and non-conductive fluid (e.g. oil-based fluid). When using a conductive fluid, the dopant should be an electrically resistive material. Conversely, when using a non-conductive (resistive) fluid, the dopant should be an electrically conductive material.

In some embodiments, the electromagnetic tool can be a deep reading resistivity tool or a multi-component and/or a tensor-resistivity tool. In some embodiments the electromagnetic tool is a PERISCOPE™, a DDR™ or a tensor resistivity tool.

### V. EXAMPLES

### Assumptions/Protocol

The various numerical simulations herein were run for situations under the following assumptions: the drilling mud is a resistive oil-based mud system of 1000 Ohm.m; fluid losses occur at the bit; a “new LCM” pill containing LCM agents of electrical conductivity equal to 0.08 ohm.m are added to the drilling mud.

An apparent LCM conductivity of a packed and electrically wired fracture going from 1000 (the original mud resistivity) to 0.08 ohm was simulated. The opposite situation would be to model a situation where a conductive water based mud of 0.08 ohm.m can be made resistive by manipulating the dielectric composition of the LCM such that the apparent LCM conductivity changes from 0.08 to 1000 ohm.m. Dielectric additives can be of any kinds, such as rubber, glass, wood, and polymers (insulating plastic) among the various possible solids. It should be noted that the overall initial mud resistivity might not change when the “new LCM” is first diluted in the original mud, but that maximum resistivity contrast would be achieved once the “new LCM” is at maximum concentration as a result of bridging and packing the fracture.

FIGS. 2-4 provide results of changing mud conductivity on new direction propagation (LWD equivalent of wireline triaxial induction) resistivity tools such as the PERISCOPE™. Such tool provides 3D information about formations far from the wellbore. It improves the accuracy of resistivity measurement in deviated wells and in dipping beds, and can measure formation dip magnitude and direction without having to make contact with the wellbore. For the particular case of identifying fluid lost, we focused on modeling the PERISCOPE™ anisotropy measurements responses in presence of fractures swarms, each fracture being 1 millimeter wide. We model the fractures densities with 1, 3 and 10 fractures/ft with symmetric invasion diameter of 2 ft or anisotropic invasion taking an ellipsoid shape of size rx and ry. We also model the response of the PERISCOPE™ for fracture occurring in a 10 Ohm-m sand, in the presence of nearby shale of resistivity 1 Ohm-m. The fractures are perpendicular to For comparison, we model the fractures invasion either with an oil based mud of Rxo=1000 Ohm-m or with a water based mud of Rxo=0.08 Ohm-m. The PERISCOPE™ transverse antenna operates at 100 kHz and 400 kHz, and combined with tilted receivers can produce anisotropy resistivity measurement of spacing 59 inches and directional first and second harmonic measurements of spacing 44 and 74 inches. Although all tool configurations were modeled, we will show representative numerical results comparing tool response for the anisotropy measurements 59 in (ANP1) at 100 kHz and 44 inches directional measurement at 400 kHz.

### Results

FIGS. 2-4 illustrate that both the resistivity attenuation measurement and the phase shift measurement of the tool show notable differences in the measured effect going from a fracture seeing a fluid at 1000 ohm.m to a fluid at 0.08 ohm.m. Such good contrast makes the PERISCOPE™ the tool of choice but it should be noted that similar results could have been simulated with a DDR™ or the tensor resistivity tool (similar to a wireline Rt Scanner) where we would have reached similar conclusions.

FIG. 2 illustrates ANP1 Anisotropy measurements (Phase Shift 59 in 100 kHz) response to fracture swarms of varied density for conductive water-based mud (WBM) 0.08 Ohm-m (left) and resistive oil-based mud (OBM) 1000 Ohm-m (right). In FIG. 2(b), measurements of 10 frac/ft, 3 frac/ft and 1 frac/ft overlay—i.e. the resistivity tool is not sensitive to fracture density in OBM. As the figure demonstrates, responses are sensitive to fracture density in WBM and not too sensitive to shape of invasion. Thus, it stands to reason that it may be advantageous to formulate an LCM composition, including doping a conventional LCM composition, for use in an oil-based mud system such that it's conductivity would be similar to that of water-based mud or greater. Similary, it could be advantageous to formulate an LCM composition, including doping a conventional LCM composition, for use in water-based mud that is more conductive than water-based mud. Such LCM compositions could provide improved information regarding fracture density.

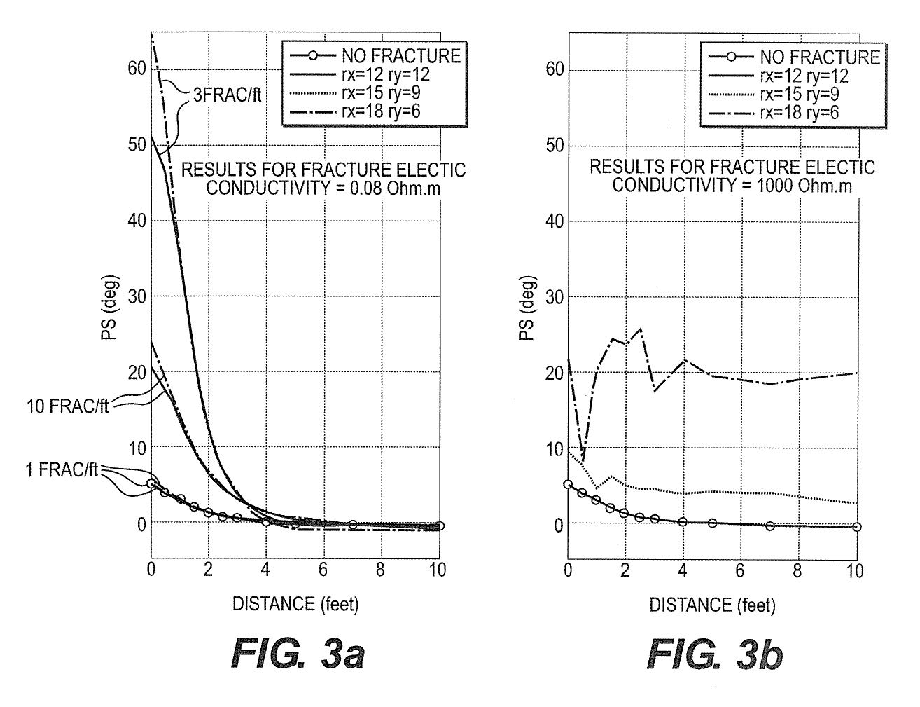

FIG. 3 provides results from the first harmonic anisotropy PS measurement—44in 400 kHz for varied fracture density and invasion shape in conductive WBM 0.08 Ohm-m (left) and resistive OBM 1000 Ohm-m (right). Again, in FIG. 3(b), the results for 10 frac/ft, 3 frac/ft and 1 frac/ft overlay. The results indicate that even far from the boundary, the measurements are sensitive to invasion shape in OBM.

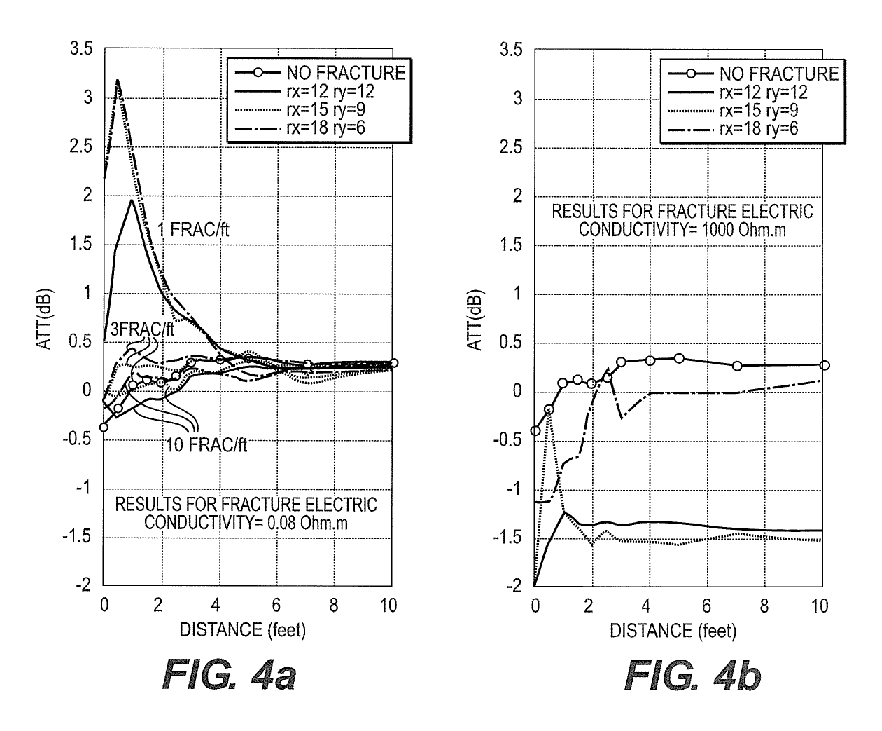

FIG. 4 provides results from the second harmonic anisotropy Attenuation measurement—44 in 400 kHz for varied fracture density and invasion shape in conductive WBM 0.08 Ohm-m (left) and resistive OBM 1000 Ohm-m (right). In FIG. 4(b), the measurements for 10 frac/ft, 3 frac/ft and 1 frac/ft overlay. FIG. 4 demonstrates, however, that far from the boundary, the measurements are sensitive to invasion shape in OBM.

It stands to reason, from the results provided in FIG. 3, that it may be advantageous to formulate an LCM composition, including doping a conventional LCM composition, for use in a water-based mud system such that its resistivity is similar to that of oil-based mud or greater. Similarly, it could be advantageous to formulate an LCM composition, including doping a conventional LCM composition, for use in an oil-based mud system such that its resistivity is greater than that of the oil-based drilling mud. Such LCM compositions could provide improved information regarding fracture shape.

These results clearly establish that the Phase Shift measurement is very sensitive to the conductivity of the fluid in a swarm of fracture at least 3 frac/ft when altering the conductivity of the fracture invaded LCM from 1000 ohm.m to 0.08 ohm.m. Note that in the case of 0.08 ohm.m simulation, the resistivity measurements are rather insensitive to the anisotropy of the fracture. Results of the simulation show that a 1 mm fracture width every foot is difficult to detect but a fracture swarm with three 1mm wide fracture every foot should be noticeable.

Results from the numerical simulation for all tool configurations can be summarized as:
Change to the mud resistivity from very conductive to very resistive affects the PERISCOPE™ tool responses to invaded fractures;
Sensitivity is dependent on fracture aperture, shape of the invasion and mud resistivity;
For test cases simulated, density should be more than 3 frac/ft (for 1 mm fractures);
For resistive OBM, tool responses are not sensitive to fracture density, just size and shape. Accordingly, it may be advantageous to utilize LCM compositions with enhanced dielectric properties to enable the use of tools to obtain information relating to fracture density.

It is clear from these numerical simulations that maximum contrast between two different fluid systems can be measured by the PERISCOPE™. Resistivity measurements could allow differentiating a conductive “new LCM” from a conventional one. In certain embodiments, the methods used in the simulation and related methods are advantageously used with fracture density of at least 3 mm/foot (3 fractures 1 mm wide every foot).

In other embodiments, the methods used in the simulations and related methods are used to detect fractures filled with conductive material in the presence of oil based mud, as more conductive material s can make the induction resistivity measurement more sensitive. Oil based muds are very resistive (1000 ohm.m) and induction resistivity tools are less sensitive in such environments. The resulting effect of packing fractures with conductive materials would improve the operation of laterolog LWD resistivity tools such as esistivity-at-the-bit (RAB) or GeoVision Resistivity (GVR) tools (e.g. make the RAB or GVR tools work adequately) in oil based mud as a means to identify leaky fractures in an oil-based system. This technique of adding a conductive pill to oil based mud could be generalized to open hole logging in oil based mud where all induction resistivity measurements such as the RT Scanner would be able to see a fracture network provided that each of these fractures taking fluid losses are capable of retaining electrically conductive additives placed in the mud. In some embodiments, materials changing the magnetic susceptibility (Mu) of the fluid are not added to the fluid as such materials may negatively impact the D&M capability to measure orientation.

A number of embodiments have been described. Nevertheless it will be understood that various modifications may be made without departing from the spirit and scope of the invention. Accordingly, other embodiments are included as part of the invention and may be encompassed by the attached claims. Furthermore, the foregoing description of various embodiments does not necessarily imply exclusion. For example, “some” embodiments or “other” embodiments may include all or part of “some”, “other,” “further,” and “certain” embodiments within the scope of this invention.

What is claimed is:

1. A lost circulation composition formulated to have an in situ conductivity or resistivity sufficiently greater than a drilling mud to which it is added such that a downhole resistivity tool can distinguish the composition in situ from the drilling mud and formation.

2. A lost circulation composition according to claim 1, wherein the downhole resistivity tool is a deep directional resistivity tool or a tensor resistivity tool.

3. A lost circulation composition according to claim 1, wherein when the drilling mud is conductive, the composition is resistive, and when the drilling fluid is non-conductive the composition is conductive.

4. A composition, comprising:
i. a Lost Circulation Material (“LCM”); and
ii. a dopant, wherein the dopant is present in an amount sufficient to electrically enhance the response of an electromagnetic tool.

5. A composition according to claim 4, wherein the dopant is chosen from dielectric materials.

6. A composition according to claim 4, wherein the dopant is chosen from: rubber, glass, wood, insulating polymers, conductive fibers, metallic particles and mixtures thereof.

7. A composition according to claim 4, wherein the dopant is present in an amount ranging from about 0.5 lbm/bbl to about 400 lbm/bbl.

8. A composition according to claim 4, wherein the LCM is compatible with a non-conductive drilling fluid and the dopant has an electrical conductivity ranging from about 1 S/m to about 5×10̂7 S/m.

9. A composition according to claim 4, wherein the LCM is compatible with a conductive drilling fluid and the dopant has an electrical resistivity ranging from about 100 Ohm.m to about 10̂25 Ohm.m.

10. A composition according to claim 8, wherein when in use, the composition results in a mud resistivity change in a fracture from about 100 ohm .m or more corresponding to the original drilling fluid resistivity to about 1 ohm.m.

11. A composition according to claim 8, wherein when in use, the composition results in a mud resistivity change in a fracture from about 2 ohm.m or more corresponding to the original drilling fluid resistivity to about 0.1 ohm.m or less.

12. A composition according to claim 9, wherein when in use, the composition results in a resistivity increase in a fracture from about 1 ohm.m or less corresponding to the original drilling fluid resistivity to about 100 ohm.m or higher.

13. A composition, comprising:
i. an LCM; and
ii. a dopant, wherein the dopant is present in an amount sufficient to electrically enhance the resistivity contrast between a reservoir rock and a region of a wellbore taking fluid loss when the composition is present in the fluid loss region relative to the LCM alone.

14. A method, comprising:
i. adding to a drilling fluid an LCM composition designed to change electrical properties of the drilling fluid; and
ii. using a resistivity tool to take one or more measurements in a wellbore in the presence of the drilling fluid including the LCM composition.

15. A method of detecting fluid loss location in a wellbore, comprising:
i. adding an LCM composition to a drilling fluid, wherein the LCM composition is designed to change electric properties of the drilling fluid;
ii. moving a bottom hole assembly (“BHA”) comprising a resistivity tool through a wellbore with the drilling fluid including the LCM composition disposed therein; and
iii. using the resistivity tool to acquire resistivity measurements while the BHA is moving through the wellbore.

16. A method according to claim 15, further comprising identifying a location of resistivity measurements that are high compared to resistivity measurements taken with drilling fluid absent the LCM composition.

17. A method according to claim 15, wherein adding is initiated after a loss starts while drilling.

18. A method according to claim 15, wherein the drilling fluid is one of a conductive drilling fluid or a non-conductive drilling fluid, and the LCM composition results in a resistivity measurement change in a fracture relative to the drilling fluid absent the LCM composition.

19. A method according to claim 15, wherein the tool is chosen from a PERISCOPE™, a deep directional resistivity tool, a multi-component or tensor resistivity tool, or an RT Scanner.

20. A method according to claim 15, wherein the resistivity measurements are acquired while the BHA is moved from the bottom of the wellbore to a first casing shoe, or between casing shoes.

21. A method of mitigating fluid loss in a wellbore, comprising:
i. adding an LCM composition to a drilling fluid in a wellbore experiencing fluid loss, wherein the LCM composition is formulated to have a greater resistivity than the drilling mud if the drilling mud is conductive, and is formulated to have a greater conductivity than the drilling mud if the drilling mud is non-conductive;
ii. while a BHA comprising a resistivity tool is at the bottom of the wellbore, moving the BHA from the wellbore bottom to a casing shoe;
iii. acquiring resistivity measurements while moving the BHA, wherein comparatively high resistivity measurements relative to resistivity measurements of drilling fluid absent the LCM composition correspond to a location of fluid loss;
iv. identifying the location of fluid loss;
v. placing the BHA at the top of the location of fluid loss; and
vi. pumping an LCM which is optionally electrically-doped into the wellbore.

22. A method according to claim 21, wherein the LCM composition comprises a dopant for enhancing the electrical properties of the LCM composition.

23. A method according to claim 21, further comprising: g. tuning a concentration of particulate in the LCM composition or tuning a concentration of LCM composition in the drilling fluid or both until the fluid loss is stopped.

24. A method according to claim 23, further comprising iteratively performing steps a-f and g, if necessary, until the fluid loss is stopped.

25. A system, comprising: a downhole assembly comprising an electromagnetic tool responsive to a composition comprising an LCM composition formulated to enhance a response of the electromagnetic tool at least when the composition is deployed in a region of loss; and, a processor capable of analyzing data acquired from the electromagnetic tool.

26. A system according to claim 25, wherein the LCM composition comprises a dielectric additive in an amount sufficient to enhance the response of the tool when the composition is deployed in a region of loss.

27. A system according to claim 25, wherein the processer analyzes the data to determine one or more of the location of the fracture, shape of the fracture, and density of fractures.

28. A system according to claim 27, wherein the processor is also capable of analyzing data to suggest optimizing modifications to the composition and optimizing modifications to the amount of composition in the drilling fluid.

29. A system according to claim 25 or 26, wherein the system further comprises drilling mud to which a composition comprising the LCM composition have been added.
